(19) United States
(12) Patent Application Publication
(10) Pub. No.: US 2026/0349713 A1
(43) Pub. Date: Nov. 5, 2026

(54) COMMON MULTI-AGENT FRAMEWORK FOR DIFFERENT AGENTIC BACKENDS

(71) Applicant: NUTANIX, INC., San Jose, CA (US)

(72) Inventors: Johnu GEORGE, Bangalore (IN); SNEHLATA, Bengaluru (IN); Jay PRASAD, Bengaluru (IN)

(21) Appl. No.: 19/379,144

(22) Filed: Nov. 4, 2025

(30) Foreign Application Priority Data
May 1, 2025 (IN) 202541042162

(51) Int. Cl. G06F 8/71; G06F 11/30; G06N 3/0475

(52) U.S. Cl. CPC G06F 8/71; G06F 11/302; G06N 3/0475

(57) ABSTRACT

Common multi-agent framework for different agentic backends include one or more non-transitory computer-readable media storing program instructions that, when executed by one or more processors associated with a first computing device, cause the one or more processors to perform a method. The method includes receiving a design for an agentic system in a common agentic framework, determining a target agentic framework for the agentic system, converting the agentic system from the common agentic framework to the target agentic framework to generate a converted agentic system, and deploying the converted agentic system to a target computing environment.

### CROSS-REFERENCE TO RELATED APPLICATION

This application claims priority to Indian Provisional Patent Application entitled “COMMON MULTI-AGENT FRAMEWORK FOR DIFFERENT AGENTIC BACKENDS” having serial number 202541042162 and filed on May. 1, 2025. The subject matter of this related application is incorporated by reference herein.

### BACKGROUND

### FIELD OF THE VARIOUS EMBODIMENTS

Embodiments of the present invention relate generally to agent-based intelligent systems and more specifically to a common multi-agent framework for different agentic backends.

### DESCRIPTION OF THE RELATED ART

Artificial Intelligence (AI) has undergone a shift in recent years, moving from rule-based systems to deep learning-powered Generative AI (Gen AI). Gen AI applications like ChatGPT, Co-Pilot, and DALL.E excel at creating content such as text, images, music, and code, which enhances creativity and ideation. However, these Gen AI applications rely on human input to define context and goals. This limits the autonomy of these Gen AI applications. For instance, while chat-based large language models (LLMs) are highly effective at answering questions based on a given resource, these LLMs cannot act autonomously on tasks like booking a plane ticket and/or the like. This gap has led to the emergence of Agentic AI.

Agentic systems use AI agents to not just generate or execute. AI agents are intelligent systems that perceive, reason and act. These agents can plan, navigate, solve problems, automate workflows, run entire systems, and/or make decisions at scale. The actions of the AI agents depend on the objectives of users or the LLMs powering the agentic systems.

An agentic system is often built around an LLM, one or more tools, and a memory system. The LLM serves as the brains of the agentic system. The LLM orchestrates the actions to take based on the object and history or previously taken actions. The tools enable the LLM to perform actions in the real world. For example, an agentic system can invoke a web search tool to gain more context information regarding a query posed by a user by searching the web. Users can also define custom tools that interact with various services. Tools allow the agentic system to act on the environment of the agentic system. The memory system provides the context for the agentic system.

One drawback of agentic systems is that there are numerous development frameworks or backends in which a developer can choose to develop an agentic system. Each of the backends has strengths and weaknesses so that a first agentic system might be well-suited to a first backend while a second agentic system might be better suited to a second backend. As a result, a developer has to not only learn which backend is best for a proposed agentic system but also has to learn how to develop within the selected backend. This creates a development bottleneck because the developer has to learn how to use the selected backend. This slows down development and distracts the developer from focusing on the use cases for the proposed agentic system. Additionally, the agentic backend that is selected for the agentic system may only be well-suited to certain components of an overall agentic system. This selectivity can reduce the effectiveness of the agentic framework in the overall agentic system with regards to efficiency or overall task success.

As the foregoing indicates, a need exists in the art for methods and systems that provide for a common multi-agent framework for different agentic backends.

### SUMMARY

In various embodiments, one or more non-transitory computer-readable media storing program instructions that, when executed by one or more processors associated with a first computing device, cause the one or more processors to perform a method. The method includes receiving a design for an agentic system in a common agentic framework, determining a target agentic framework for the agentic system, converting the agentic system from the common agentic framework to the target agentic framework to generate a converted agentic system, and deploying the converted agentic system to a target computing environment.

Further embodiments provide, among other things, methods and systems for implementing one or more aspects of the disclosed techniques.

At least one technical advantage of the disclosed techniques relative to the prior art is that with the disclosed techniques, the target agentic framework for an agentic system design is determined automatically. As a result, the agentic system can utilize an appropriate target agentic framework that may not be known by the developer as the target agentic framework of the agentic system. An additional technical advantage of the disclosed techniques is that the agentic system is monitored after deployment allowing agentic system to be automatically scaled, configured with additional resources, and/or converted to a different target agentic framework that is more suitable for the design and/or workload of the agentic system. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIGS. 1A-1D are block diagrams illustrating virtualization system architectures configured to implement one or more aspects of the present embodiments.

FIG. 2 is a block diagram illustrating a computing environment configured to implement one or more aspects of the present embodiments.

FIG. 3 is a block diagram of an agentic system, according to various embodiments.

FIG. 4 is a process flow illustrating monitoring and redeployment of an agentic system, according to various embodiments.

FIG. 5 is a flow diagram of method steps for converting an agentic system to a target agentic framework, according to various embodiments.

FIG. 6 is a flow diagram of method steps for monitoring and redeploying an agentic system, according to some embodiments.

### DETAILED DESCRIPTION

In the following description, various concepts and examples are disclosed that provide more effective techniques for accessing business data using executable code included in authorization identifiers. The numerous specific details set forth will provide artisans with a more thorough understanding of the various embodiments. However, it will be apparent to one skilled in the art that the inventive concepts can be practiced without one or more of these specific details.

### Exemplary Virtualization System Architectures

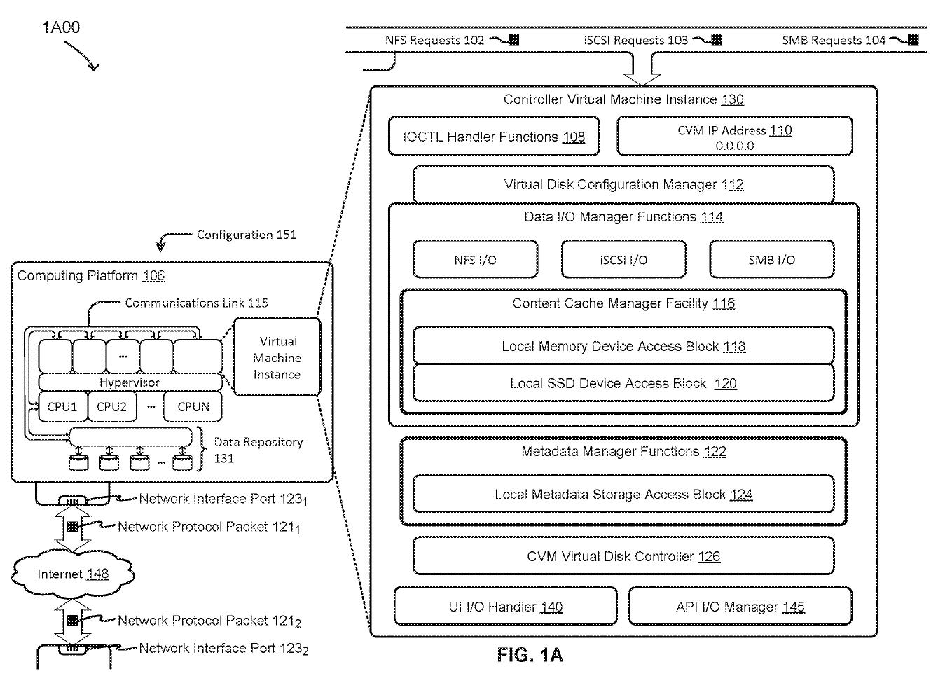

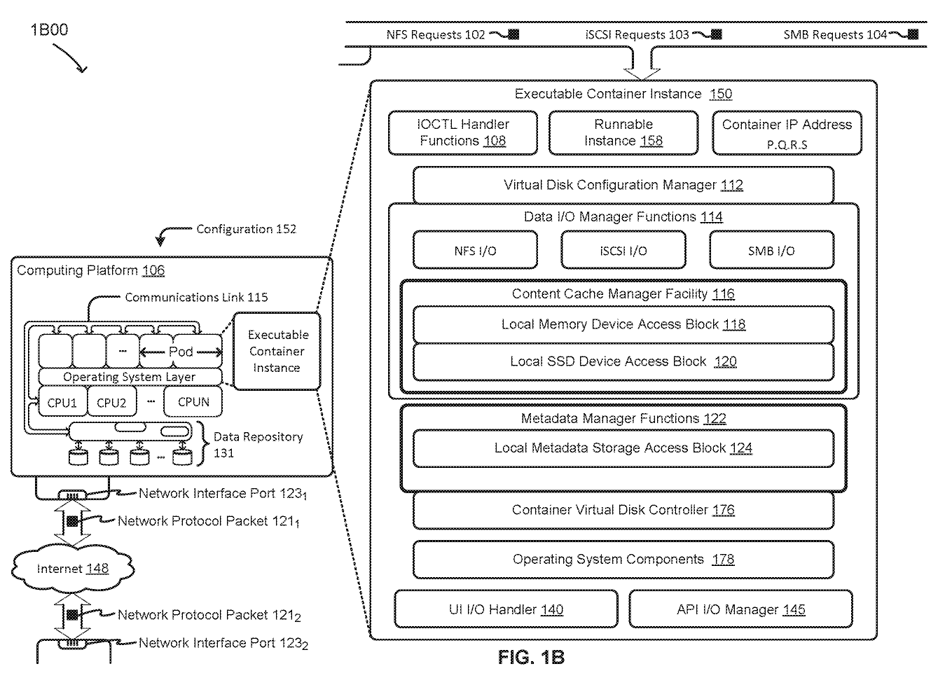

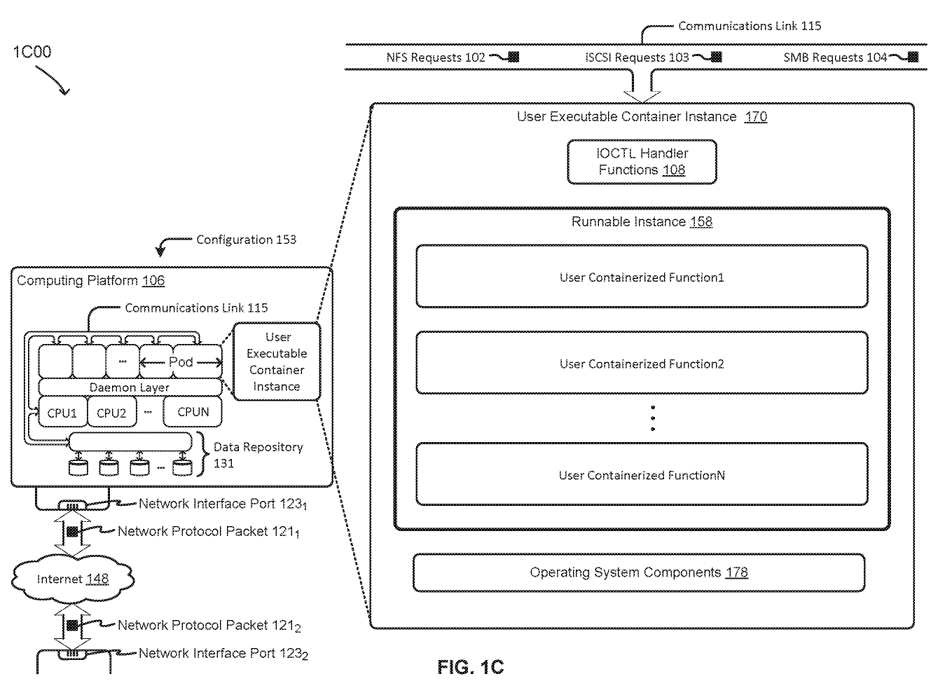

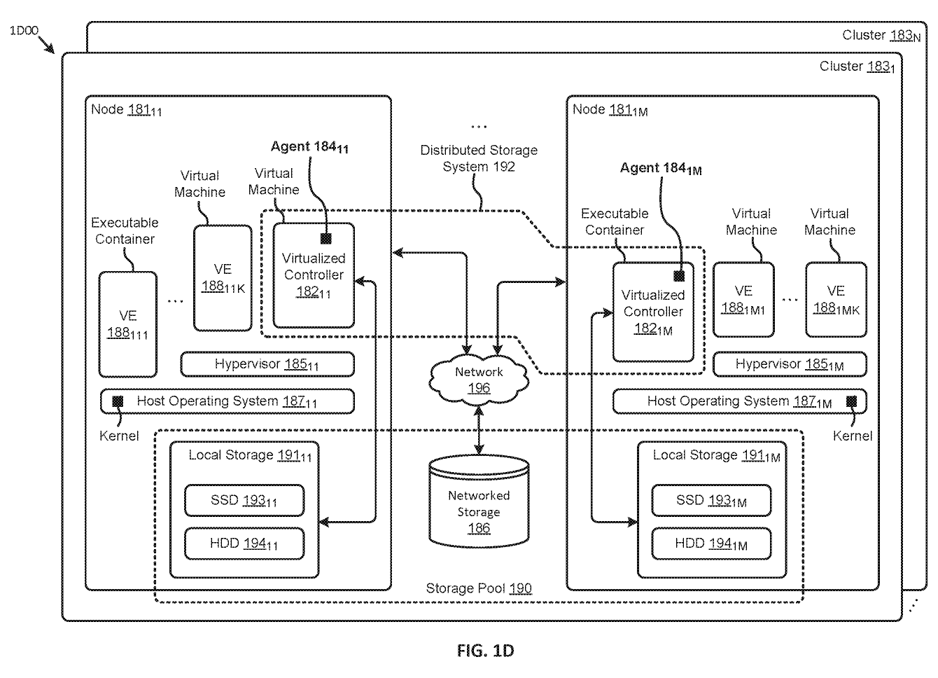

According to some embodiments, all or portions of any of the disclosed techniques can be partitioned into one or more modules and instances within, or as, or in conjunction with a virtualized controller in a virtual computing environment. Some example instances within various virtual computing environments are shown and discussed in further detail in FIGS. 1A-1D. Consistent with these embodiments, a virtualized controller includes a collection of software instructions that serve to abstract details of underlying hardware or software components from one or more higher-level processing entities. In some embodiments, a virtualized controller can be implemented as a virtual machine, as an executable container, or within a layer (e.g., such as a layer in a hypervisor). Consistent with these embodiments, distributed systems include collections of interconnected components that are designed for, or dedicated to, storage operations as well as being designed for, or dedicated to, computing and/or networking operations.

In some embodiments, interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or computing resources, while a second set of components of the same distributed computing system can coordinate to efficiently use the same or a different set of data storage facilities.

In some embodiments, a hyperconverged system coordinates the efficient use of computing and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

In some embodiments, physical and/or logical collections of such autonomous entities can sometimes be referred to as nodes. In some hyperconverged systems, computing and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

FIG. 1A is a block diagram illustrating virtualization system architecture 1A00 configured to implement one or more aspects of the present embodiments. As shown in FIG. 1A, virtualization system architecture 1A00 includes a collection of interconnected components, including a controller virtual machine (CVM) instance 130 in a configuration 151. Configuration 151 includes a computing platform 106 that supports virtual machine instances that are deployed as user virtual machines, or controller virtual machines or both. Such virtual machines interface with a hypervisor (as shown). In some examples, virtual machines can include processing of storage I/O (input/output or IO) as received from any or every source within the computing platform. An example implementation of such a virtual machine that processes storage I/O is depicted as CVM instance 130.

In this and other configurations, a CVM instance receives block I/O storage requests as network file system (NFS) requests in the form of NFS requests 102, internet small computer storage interface (iSCSI) block IO requests in the form of iSCSI requests 103, Samba file system (SMB) requests in the form of SMB requests 104, and/or the like. The CVM instance publishes and responds to an internet protocol (IP) address (e.g., CVM IP address 110). Various forms of input and output can be handled by one or more IO control handler functions (e.g., IOCTL handler functions 108) that interface to other functions such as data IO manager functions 114 and/or metadata manager functions 122. As shown, the data IO manager functions can include communication with virtual disk configuration manager 112 and/or can include direct or indirect communication with any of various block IO functions (e.g., NFS IO, iSCSI IO, SMB IO, etc.).

In addition to block IO functions, configuration 151 supports IO of any form (e.g., block IO, streaming IO, packet-based IO, HTTP traffic, etc.) through either or both of a user interface (UI) handler such as UI IO handler 140 and/or through any of a range of application programming interfaces (APIs), possibly through API IO manager 145.

Communications link 115 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), formatting of bit fields into fixed-length blocks or into variable length fields used to populate the payload, and/or the like. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry can be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

Computing platform 106 includes one or more computer readable media that is capable of providing instructions to a data processor for execution. In some examples, each of the computer readable media can take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random-access persistent memories (RAPMs) or optical or magnetic media drives such as paper tape or magnetic tape drives. Volatile media includes dynamic memory such as random-access memory (RAM). As shown, controller virtual machine instance 130 includes content cache manager facility 116 that accesses storage locations, possibly including local dynamic random-access memory (DRAM) (e.g., through local memory device access block 118) and/or possibly including accesses to local solid-state storage (e.g., through local SSD device access block 120).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 131, which in turn can be formatted into any one or more storage areas, and which can comprise parameterized storage accessible by a key (e.g., a filename, a table name, a block address, an offset address, etc.). Data repository 131 can store any forms of data and can comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 124. The data repository 131 can be configured using CVM virtual disk controller 126, which can in turn manage any number or any configuration of virtual disks.

Execution of a sequence of instructions to practice certain of the disclosed embodiments is performed by one or more instances of a software instruction processor, or a processing element such as a data processor, or such as a central processing unit (e.g., CPU1, CPU2, …, CPUN). According to certain embodiments of the disclosure, two or more instances of configuration 151 can be coupled by communications link 115 (e.g., backplane, LAN, PSTN, wired or wireless network, etc.) and each instance can perform respective portions of sequences of instructions as can be required to practice embodiments of the disclosure.

The shown computing platform 106 is interconnected to the Internet 148 through one or more network interface ports (e.g., network interface port 123₁and network interface port 123₂). Configuration 151 can be addressed through one or more network interface ports using an IP address. Any operational element within computing platform 106 can perform sending and receiving operations using any of a range of network protocols, possibly including network protocols that send and receive packets (e.g., network protocol packet 121₁and network protocol packet 121₂).

Computing platform 106 can transmit and receive messages that can be composed of configuration data and/or any other forms of data and/or instructions organized into a data structure (e.g., communications packets). In some cases, the data structure includes program instructions (e.g., application code) communicated through the Internet 148 and/or through any one or more instances of communications link 115. Received program instructions can be processed and/or executed by a CPU as it is received and/or program instructions can be stored in any volatile or non-volatile storage for later execution. Program instructions can be transmitted via an upload (e.g., an upload from an access device over the Internet 148 to computing platform 106). Further, program instructions and/or the results of executing program instructions can be delivered to a particular user via a download (e.g., a download from computing platform 106 over the Internet 148 to an access device).

Configuration 151 is merely one example configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

In some embodiments, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to management of block stores. Various implementations of the data repository comprise storage media organized to hold a series of records and/or data structures.

Further details regarding general approaches to managing data repositories are described in U.S. Patent No. 8,601,473 titled “ARCHITECTURE FOR MANAGING I/O AND STORAGE FOR A VIRTUALIZATION ENVIRONMENT,” issued on Dec. 3, 2013, which is hereby incorporated by reference in its entirety.

Further details regarding general approaches to managing and maintaining data in data repositories are described in U.S. Patent No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT,” issued on Oct. 1, 2013, which is hereby incorporated by reference in its entirety.

FIG. 1B depicts a block diagram illustrating another virtualization system architecture 1B00 configured to implement one or more aspects of the present embodiments. As shown in FIG. 1B, virtualization system architecture 1B00 includes a collection of interconnected components, including an executable container instance 150 in a configuration 152. Configuration 152 includes a computing platform 106 that supports an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In some embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node can communicate directly with storage devices on the second node.

The operating system layer can perform port forwarding to any executable container (e.g., executable container instance 150). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and can include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls” or “ls -a”, etc.). The executable container might optionally include operating system components 178, however such a separate set of operating system components need not be provided. As an alternative, an executable container can include runnable instance 158, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 176. Such a container virtual disk controller can perform any of the functions that the aforementioned CVM virtual disk controller 126 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 1C is a block diagram illustrating virtualization system architecture 1C00 configured to implement one or more aspects of the present embodiments. As shown in FIG. 1C, virtualization system architecture 1C00 includes a collection of interconnected components, including a user executable container instance in configuration 153 that is further described as pertaining to user executable container instance 170. Configuration 153 includes a daemon layer (as shown) that performs certain functions of an operating system.

User executable container instance 170 comprises any number of user containerized functions (e.g., user containerized function1, user containerized function2, …, user containerized functionN). Such user containerized functions can execute autonomously or can be interfaced with or wrapped in a runnable object to create a runnable instance (e.g., runnable instance 158). In some cases, the shown operating system components 178 comprise portions of an operating system, which portions are interfaced with or included in the runnable instance and/or any user containerized functions. In some embodiments of a daemon-assisted containerized architecture, computing platform 106 might or might not host operating system components other than operating system components 178. More specifically, the shown daemon might or might not host operating system components other than operating system components 178 of user executable container instance 170.

In some embodiments, the virtualization system architecture 1A00, 1B00, and/or 1C00 can be used in any combination to implement a distributed platform that contains multiple servers and/or nodes that manage multiple tiers of storage where the tiers of storage might be formed using the shown data repository 131 and/or any forms of network accessible storage. As such, the multiple tiers of storage can include storage that is accessible over communications link 115. Such network accessible storage can include cloud storage or networked storage (e.g., a SAN or storage area network). Unlike prior approaches, the disclosed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In some embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

In some embodiments, any one or more of the aforementioned virtual disks can be structured from any one or more of the storage devices in the storage pool. In some embodiments, a virtual disk is a storage abstraction that is exposed by a controller virtual machine or container to be used by another virtual machine or container. In some embodiments, the virtual disk is exposed by operation of a storage protocol such as iSCSI or NFS or SMB. In some embodiments, a virtual disk is mountable. In some embodiments, a virtual disk is mounted as a virtual storage device.

In some embodiments, some or all of the servers or nodes run virtualization software. Such virtualization software might include a hypervisor (e.g., as shown in configuration 151) to manage the interactions between the underlying hardware and user virtual machines or containers that run client software.

Distinct from user virtual machines or user executable containers, a special controller virtual machine (e.g., as depicted by controller virtual machine instance 130) or as a special controller executable container is used to manage certain storage and I/O activities. Such a special controller virtual machine is sometimes referred to as a controller executable container, a service virtual machine (SVM), a service executable container, or a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 1D is a block diagram illustrating virtualization system architecture 1D00 configured to implement one or more aspects of the present embodiments. As shown in FIG. 1D, virtualization system architecture 1D00 includes a distributed virtualization system that includes multiple clusters (e.g., cluster 183₁, …, cluster 183_{N}) comprising multiple nodes that have multiple tiers of storage in a storage pool. Representative nodes (e.g., node 181₁₁, …, node 181_{1M}) and storage pool 190 associated with cluster 183₁are shown. Each node can be associated with one server, multiple servers, or portions of a server. The nodes can be associated (e.g., logically and/or physically) with the clusters. As shown, the multiple tiers of storage include storage that is accessible through a network 196, such as a networked storage 186 (e.g., a storage area network or SAN, network attached storage or NAS, etc.). The multiple tiers of storage further include instances of local storage (e.g., local storage 191₁₁, …, local storage 191_{1M}). For example, the local storage can be within or directly attached to a server and/or appliance associated with the nodes. Such local storage can include solid state drives (SSD 193₁₁, …, SSD 193_{1M}), hard disk drives (HDD 194₁₁, …, HDD 194_{1M}), and/or other storage devices.

As shown, any of the nodes of the distributed virtualization system can implement one or more user virtualized entities (e.g., VE 188¹¹¹, …, VE 188^{11K}, …, VE 188^{1M1}, …, VE 188^{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 187¹¹, …, host operating system 187^{1M}), while the VMs run multiple applications on various respective guest operating systems. Such flexibility can be facilitated at least in part by a hypervisor (e.g., hypervisor 185¹¹, …, hypervisor 185^{1M}), which hypervisor is logically located between the various guest operating systems of the VMs and the host operating system of the physical infrastructure (e.g., node).

As an alternative, executable containers can be implemented at the nodes in an operating system-based virtualization environment or in a containerized virtualization environment. The executable containers are implemented at the nodes in an operating system virtualization environment or container virtualization environment. The executable containers can include groups of processes and/or resources (e.g., memory, CPU, disk, etc.) that are isolated from the node host computer and other containers. Such executable containers directly interface with the kernel of the host operating system (e.g., host operating system 187₁₁, …, host operating system 187_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 190 by the VMs and/or the executable containers.

Multiple instances of such virtualized controllers can coordinate within a cluster to form the distributed storage system 192 which can, among other operations, manage the storage pool 190. This architecture further facilitates efficient scaling in multiple dimensions (e.g., in a dimension of computing power, in a dimension of storage space, in a dimension of network bandwidth, etc.).

In some embodiments, a particularly configured instance of a virtual machine at a given node can be used as a virtualized controller in a hypervisor-assisted virtualization environment to manage storage and I/O (input/output or IO) activities of any number or form of virtualized entities. For example, the virtualized entities at node 181₁₁can interface with a controller virtual machine (e.g., virtualized controller 18211) through hypervisor 185₁₁to access data of storage pool 190. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 192. For example, a hypervisor at one node in the distributed storage system 192 might correspond to software from a first vendor, and a hypervisor at another node in the distributed storage system 192 might correspond to a second software vendor. As another virtualized controller implementation example, executable containers can be used to implement a virtualized controller (e.g., virtualized controller 182_{1M}) in an operating system virtualization environment at a given node. In this case, for example, the virtualized entities at node 181_{1M} can access the storage pool 190 by interfacing with a controller container (e.g., virtualized controller 182_{1M}) through hypervisor 185_{1M} and/or the kernel of host operating system 187_{1M}.

In some embodiments, one or more instances of an agent can be implemented in the distributed storage system 192 to facilitate the herein disclosed techniques. Specifically, agent 184₁₁can be implemented in the virtualized controller 182₁₁, and agent 184_{1M} can be implemented in the virtualized controller 182_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or the agents.

### Computing Framework for a Common Multi-agent Framework for Different Agentic Backends

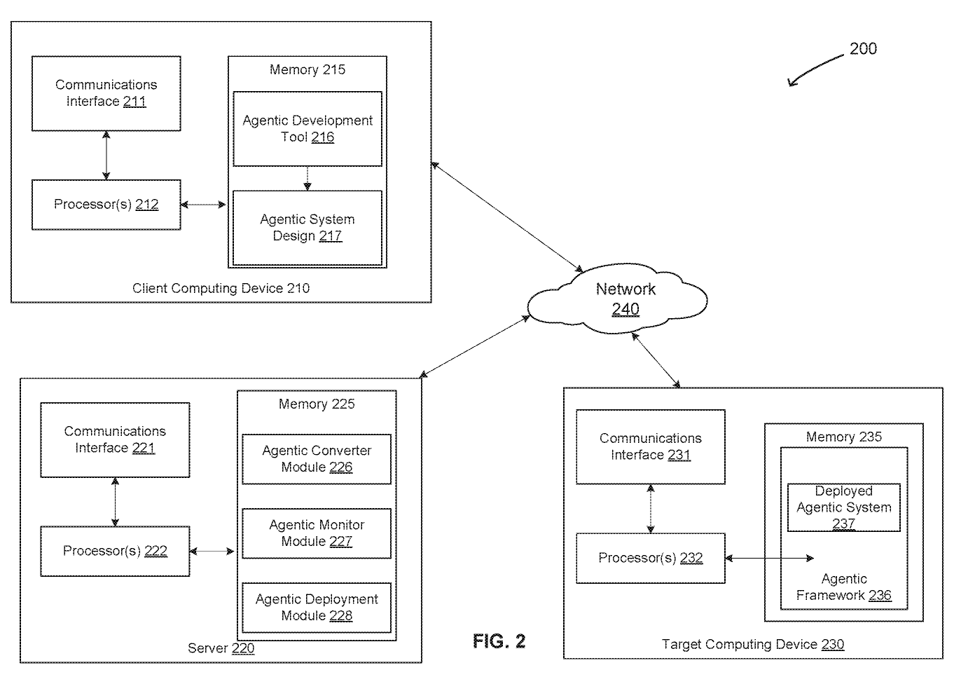

FIG. 2 is a block diagram illustrating a computing environment 200 configured to implement one or more aspects of the present embodiments. As shown, computing environment 200 includes, without limitation, a client computing device 210, a server 220, a target computing device 230, and a network 240. Client computing device 210 includes, without limitation, a communications interface 211, one or more processors 212, and memory 215. Memory 215 includes, without limitation, an agentic development tool 216 and an agentic system design 217. Server 220 includes, without limitation, a communications interface 221, one or more processors 222, and memory 225. Memory 225 includes, without limitation, an agentic converter module 226, an agentic monitor module 227, and an agentic deployment module 228. Target computing device 230 includes, without limitation, a communications interface 231, one or more processors 232, and memory 235. Memory 235 includes, without limitation, an agentic framework 236, and one or more deployed agentic systems 237.

Computing environment 200 described herein is illustrative and any other technically feasible configurations fall within the scope of the present disclosure. For example, server 220 and target computing device 230 can be located and executed on the same computing device. In the context of this disclosure, any of the computing elements shown in the computing environment 200 can correspond to a physical computing system (e.g., a system in a data center) or can include a virtual computing instance. In various embodiments, the components of the computing environment 200 can be included in any combination of the virtualization system architectures shown in FIGS. 1A-1D.

The one or more processors 212 include any suitable processors implemented as a central processing unit (CPU), a graphics processing unit (GPU), an application-specific integrated circuit (ASIC), a field programmable gate array (FPGA), an artificial intelligence (AI) accelerator, any other type of processor, or a combination of different processors, such as a CPU configured to operate in conjunction with a GPU. In general, the one or more processors 212 can be any technically feasible hardware unit capable of processing data and/or executing software applications.

Memory 215 includes a random-access memory (RAM) module, a flash memory unit, and/or any other type of memory unit or combination thereof. The one or more processors 212 and/or communications interface 211 are configured to read data from and write data to memory 215. Memory 215 can further include additional types of storage including, but not limited to, one or more fixed or removable disk drives, HDDs, SSD, NVMes, vDisks, flash memory devices, and/or other magnetic, optical, and/or solid-state storage devices. Memory 215 includes various software programs that include one or more instructions that can be executed by the one or more processors 212 and application data associated with those software programs. As shown, memory 215 includes agentic development tool 216 and agentic system design 217.

Communications interface 211 includes any technically feasible interface for coupling client computing device 210 and the one more processors 212 with network 240. Communications interface 211 can include one or more hardware or software components. For example, communications interface 211 can provide an interface that is compliant with one or more wired or wireless Ethernet standards, and/or the like.

As described herein, the client computing device 210 includes the agentic development tool 216. In at least one embodiment, the agentic development tool 216 includes a user interface and development environment suitable for developing an agentic system in a common agentic framework. An example environment for developing an agentic system can include common software development tools such as autocomplete for commonly used syntax, formatting checks, and/or the like. The user interface for this development environment can be a text editor with the aforementioned integrated tools, a pre-configured document with configuration templates, or examples of agentic systems designed for target agentic frameworks. In some embodiments, agentic development tool 216 includes a graphical user interface (GUI) that provides a drag and drop interface of commonly deployed agent(s), LLM(s), text-based input for runtime parameters such as supplied API keys, tools, and/or the like. Agentic development tool 216 can also provide an LLM based chat agent that can answer questions in natural language. In some embodiments, the LLM in agentic development tool 216 parses the results of one or more agents to provide in-depth information of the state of the deployed agentic system 237. The completed agentic system in the common agentic framework is saved as agentic system design 217.

Agentic system design 217 contains the initial elements of an agentic system in a common agentic framework. The common agentic framework of agentic system design 217 also provides the system with initial deployment details, such as callable locations to reach desired agent(s) and/or tool(s). For example, these callable locations could refer to published virtual code environments, such as Docker containers, APIs on the internet, and/or the like. In some embodiments, the common agentic framework of agentic system design 217 contains descriptions of the one or more agents, one or more tools, desired results of the agentic system, one or more example prompts that will be sent to an LLM, and/or the like. In some embodiments, agentic system design 217 is specified using one or more Kubernetes common resource definitions.

The common agentic framework of agentic system design 217 provides the system with a common input and output format for use in agentic framework 236. Agentic system design 217 can be represented in a configuration text file which provides the input to one or more of the components of agentic framework 236, such as in JavaScript Object Notation (JSON) or Yet Another Markup Language (YAML). The common input and output would ensure compatibility of this configuration file in scenarios where agents cannot natively accept this format. An example of an agent that has limited input options would be the open-source agent HuggingFace SmolAgent, which does not accept input in YAML, a common format for virtualized computing environments. The common agentic framework for the agentic system would create an input layer that translates agentic system design 217 into a format that the HuggingFace Smolagents can accept, such as JSON

Agentic system design 217 also describes a controller module for one or more agents of an agentic system. A controller module interacts with elements of the agentic system including, but not limited to, one or more LLMs, one or more agents, and one or more tools that the agent(s) require to act in the agentic system. A controller module also provides data on the state of the running agentic system to agentic monitor module 227. In some embodiments, the common agentic framework contains elements of the target computing environment for the target agentic system. Such elements of the target computing environment can be used by the controller module to coordinate elements of the agentic systems.

Once agentic system design 217 is completed, agentic system design 217 is provided to agentic converter module 226 for further processing. For example, agentic system design 217 can be transmitted to agentic converter module 226 through an API of agentic converter module 226.

Server 220 is a computing device for converting a common agentic framework to a target agentic framework and deploying such a target agentic framework. Server 220 includes, without limitation one or more processors 222, memory 225, and communications interface 221.

The one or more processors 222 include any suitable processors implemented as part of a central processing unit (CPU), a GPU, an ASIC, a FPGA, an AI accelerator, or any other type of processor, or a combination of different processors, such as a CPU configured to operate in conjunction with a GPU. In general, the one or more processors 222 can be any technically feasibly hardware unit capable of processing data and/or executing software applications.

Memory 225 includes a RAM module, a flash memory unit, and/or any other type of memory unit or combination thereof. The one or more processors 222 and/or communications interface 221 are configured to read data from and write data to memory 225. Memory 225 can further include additional types of storage including, but not limited to, one or more fixed or removable disk drives, HDDs, SSD, NVMes, vDisks, flash memory devices, and/or other magnetic, optical, and/or solid-state storage devices. Memory 225 includes various software instructions that can be executed by the one or more processors 222 and application data associated with those software programs. As shown, memory 225 includes agentic converter module 226, agentic monitor module 227, and agentic deployment module 228.

Communications interface 221 includes any technically feasible interface for coupling server 220 and the one or more processors 222 with network 240. Communications interface 221 can include one or more hardware or software components. For example, communications interface 221 can provide an interface that is compliant with one or more wired or wireless Ethernet standards, and/or the like.

Agentic converter module 226 is responsible for converting agentic system designs, such as agentic system design 217, from the common agentic framework to one or more target agentic frameworks. Agentic converter module 226 begins by receiving agentic system design 217. In some embodiments, agentic converter module 226 receives agentic system design 217 from client computing device 210 via an API. For example, when a user has completed agentic system design 217, the user could have agentic development tool 216 invoke the API to provide agentic system design 217. In some embodiments, a user using agentic converter module 226 selects a file or package containing agentic system design 217. In some embodiments, agentic converter module 226 receives agentic system design 217 from agentic monitor module 227. For example, agentic monitor module 227 can determine modifications for deployed agentic system 237 and provide the modified agentic system design to agentic converter module 226 for conversion and/or request conversion of deployed agentic system 237 to a different target agentic framework.

The agentic converter module 226 then determines a target agentic framework that is suitable in which to deploy the agentic system of agentic system design 217 based on the properties of agentic system design 217. Agentic converter module 226 uses one or more LLMs, heuristic rules, and/or the like to identify properties of agentic system design 217. In some embodiments, the heuristic rules are determined from observed behaviors of potential target agentic frameworks, publicly available documentation of the target agenting frameworks, information on a state of a possible target computing environment for the agentic system, and/or other relevant data. Examples of properties determined by agentic converter module 226 can be related to runtime details such as the execution environment that will be configured for the target agentic framework, a profile of the tasks of the agentic system, initial details of an agentic controller, and/or similar details of the agentic system. These analyzed properties are used by agentic converter module 226 to create an initial target agentic system for which further components can be generated by agentic converter module 226. In some embodiments, the user specifies one or more elements of the target agentic framework, bypassing the heuristics of agentic converter module 226. These specified elements can include which target agent(s) to use, how or when a target agentic controller of the agentic system should supply additional agent(s), the target agentic framework, or physical computing resources to the agentic system.

Agentic converter module 226 generates a controller module to manage the context of the agent(s), the LLM, and any tools of the agentic system. This controller module can simultaneously manage the inputs and outputs of heterogenous agent(s) and tools generated by the agentic converter module 226. In some embodiments, this controller module is a Kubernetes controller that continuously monitors the state of the agent(s), LLM, and any tools during execution of the agentic system. The controller module maintains the state of the agentic agent(s) by sending commands according to an action plan of the agentic system (e.g. agentic system 301) to the agents and collecting the results of such agent(s). In some embodiments, agentic converter module 226 further configures the converted agentic controller module to provide information on the state of deployed agentic system 237 to agentic monitor module 227. For example, agentic converter module 226 could add one or more reporting agents or tools to deployed agentic system 237.

Agentic converter module 226 then determines the LLM to be used for context management within the agentic system. For example, the LLM could be any of LLama, Mistral, and/or other LLMs. LLM 311 creates the action plan for the agentic system to execute to accomplish tasks requested of the agentic system described by agentic system design 217. In some embodiments, the LLM utilized by the agentic system is provided as a remote service located separate from deployed agentic system 237. For example, the remote service can be provided by ChatGPT from OpenAI, Claude from Anthropic, and/or the like. Agentic converter module 226 determines the specific LLM to utilize for the LLM based on compatibility with the agent(s) and controller module of the target agentic framework. Compatibility can be determined from heuristic rules, observations of previous LLMs deployed in agentic systems, publicly available documentation on agent(s), and/or the like. In some embodiments, agentic system design 217 can override the choice of the LLM based on user designation.

Agentic converter module 226 then determines one or more appropriate agents to use in deployed agentic system 237 based on the analysis of agentic system design 217. For example, agentic converter module 226 can use one or more LLMs, heuristic rules, and/or similar methods to determine the one or more agents or the one or more controllers.

Agentic converter module 226 then converts parameters for each of the components of agentic system design 217 from the common agentic framework to the target agentic framework selected for the agentic system. For example, each of the one or more agents and the one or more controllers in the agentic system can be supplied with necessary API credentials that are consistent with the specifications and protocols of the target agentic framework. In some embodiments, as the one or more target agents are identified, agentic converter module 226 supplies optimizations to the one or more agents. For example, these optimizations could include optimizations for such optimizing a model context protocol (MCP) interface for one or more HuggingFace SmolAgents for use with one or more of the controllers. In some embodiments, heuristic rules are developed for agentic converter module 226 that analyze and convert the components of agentic system design 217. These heuristic rules can be determined from observed runs of agentic systems within various agentic frameworks, publicly available documentation of target agent(s), information on the state of the target computing environment, and/or other relevant data.

Agentic converter module 226 then converts the one or more agents to the target agentic framework. Each of the one or more agents is created for the target agentic framework according to one or more tasks that the agent is expected to perform in deployed agentic system 237. For example, agentic converter module 226 can determine whether a task of one of the agents includes the use of one or more specific tools and then convert the one or more tools or interfaces of the one or more tools to the target agentic framework. In some embodiments, agentic converter module 226 also applies one or more optimizations and modifications to the one or more agents during the conversion process using information gathered from an LLM, heuristic rules, and/or the like. For example, each of the one more agents created can be modified independently of the other agents. Alternatively, the one or more optimizations and modifications can be applied at a group level, such as modifying each CrewAI agent with the same identified optimization. In some embodiments, agentic converter module 226 utilizes one or more prebuilt templates for standard agents in the system such as Langgraph, Microsoft's Autogen, Smolagents, and/or other specific agents. In some embodiments, agentic converter module 226 can receive requests from agentic monitor module 227 based on analysis of deployed agentic system 237 to determine appropriate agents for use in a modified deployed agentic system 237.

Agentic converter module 226 can also create agents solely for interacting with other agents of the agentic system within the target agentic framework. In some embodiments, agentic converter module 226 creates an agent that acts as a supervisory agent to other agents in the agentic system. In some embodiments, one or more supervisory agents are created in deployed agentic system 237, to create a hierarchy network of agents and supervisory agents to ensure suitable management and completion of complex tasks. For example, this supervisory agent can receive the results generated by subordinate agents, aggregate the received results, and return the aggregated result to the controller module. Additionally, a supervisory agent can provide a compatibility layer to other, more specialized agents included in the agentic system.

Agentic converter module 226 then combines the converted controller module, the converted LLM, the converted one or more agents, and any tools into a deployment package suitable for deployment in the target agentic framework. Agentic converter module 226 then provides the deployment package to agentic deployment module 228 to facilitate the deployment of deployed agentic system 237. In some embodiments, the deployment package is represented in a structured text file such as YAML or JSON. The deployment package contains the elements of deployed agentic system 237 and/or any necessary metadata for executing deployed agentic system 237.

In some embodiments, agentic converter module 226 also determines a computing environment for the target agentic system. For example, agentic converter module 226 can determine the computing environment based on analysis of the converted agents, the converted controller module, the converted LLM, and the tools included in the deployment package. Agentic converter module 226 can use one or more heuristic rules and/or algorithms to generate a template of the computing resources expected to be used by the converted controller module, the converted LLM, the converted one or more agents, and the tools of the agentic system. For example, a first heuristic rule could indicate that an agent that relies primarily on calls to tools should be allocated two CPU cores and four GB of memory. A second heuristic rule could indicate that a general-purpose agent should be allocated eight CPU cores and thirty-two GB of memory. Additional heuristic rules could also indicate resource needs for the controller module, the LLM, and/or any tools. Agentic converter module 226 can also use heuristic tools to configure target computing device 230 for executing deployed agentic system 237. Alternatively, agentic converter module 226 can configure target computing device 230 to leverage short lived, ephemeral computing environments for deployed agentic system 237.

Agentic converter module 226 then provides the identified computing environment and/or the resource requirements for the agentic system to agentic deployment module 228 along with the deployment package. In some embodiments, agentic converter module 226 is also called by agentic monitor module 227 while deployed agentic system 237 is operating on target computing device 230. Based on instructions from agentic monitor module 227, agentic converter module 226 then creates an additional or replacement target agentic system to satisfy better meet the resource and execution needs of the agentic system design 217 based on use of the agentic system. For example, when agentic monitor module 227 requests that an additional agentic system be created to replace and/or supplement deployed agentic system 237, agentic converter module 226 converts agentic system design 217 based on additional information about of the state and/or operation of deployed agentic system 237.

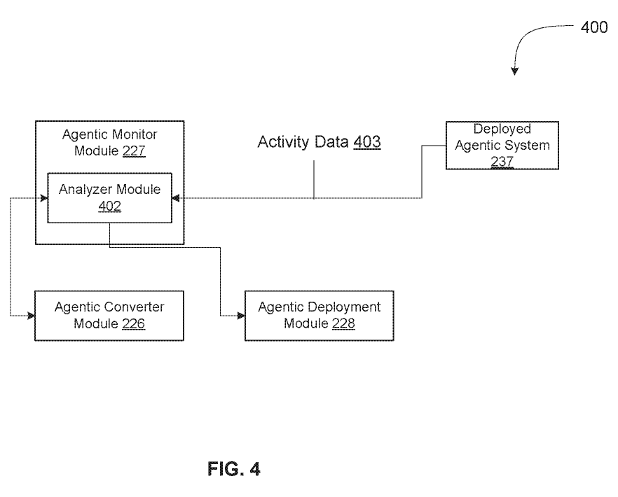

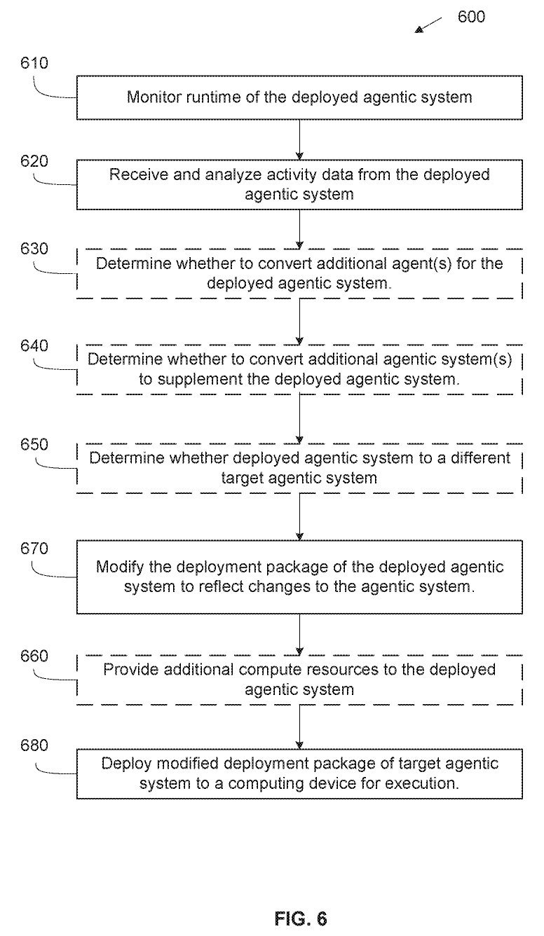

Agentic monitor module 227 receives activity data from deployed agentic system 237. Based on the activity data, agentic monitor module 227 analyzes the execution state of deployed agentic system 237. Agentic monitor module 227 uses an LLM, heuristic rules, and/or the like to determine whether deployed agentic system 237 is over or under-utilizing system computing resources, taking longer than expected to perform tasks, and/or similar observations of deployed agentic system 237. Using these and similar metrics, agentic monitor module 227 can call agentic converter module 226 to generate an additional target agentic system and coordinate with agentic deployment module 228 to deploy this additional deployed agentic system 237. In some embodiments, this additional agentic system is deployed on the same target computing device 230 as the original deployed agentic system 237. Further, this additional deployed agentic system 237 can be deployed on a second target computing device 230 to utilize additional physical computing resources, such as CPU, Memory, and/or the like. In some embodiments, agentic monitor module 227 determines that the deployed agentic system should be deployed using a different target agentic framework and can coordinate with agentic converter module 226 and agentic deployment module 228 to create a replacement deployed agentic system. Additionally, agentic monitor module 227 provides the runtime context such as the completed commands, failed command(s), and/or other runtime information from deployed agentic system 237 to the agentic converter module 226. Throughout execution of the agentic system, agentic monitor module 227 determines whether the deployed agentic system can be scaled with additional agentic systems, agents, and/or the like. Agentic monitor module 227 also determines whether the target agentic system will be likely to successfully complete the agentic design and can orchestrate the creation of new agentic systems on different target frameworks as needed. The details of this process are described in further detail in FIGS. 4 and 6.

Agentic deployment module 228 receives and executes the deployment package of the target agentic system provided by agentic convert module 226 and deploys deployed agentic system 237 on target computing device 230. In some embodiments, agentic deployment module 228 also packages and/or deploys one or more tools that can be shared by any of the agent(s) 321 of deployed agentic system 237. In some embodiments, a system administrator controls execution of agentic deployment module 228. For example, the system administrator can determine whether target computing device 230 is properly configured, has enough system resources for deployed agentic system 237, and/or similar execution conditions are met before allowing agentic deployment module 228 to deploy deployed agentic system 237.

Agentic deployment module 228 parses the deployment package and collects the deployment artifacts, such as Docker images, GitHub code locations, and/or the like on target computing device 230. During the build process of these deployment artifacts, agentic deployment module 228 modifies any of the components of deployed agentic system 237 according to the specification. For example, agentic deployment module 228 can modify one or more tools with an MCP layer to ensure communication with any agent(s) calling the tool. In some embodiments, agentic deployment module 228 supplies the components of deployed agentic system 237 with any necessary credentials and/or static parameters for API(s).

Target computing device 230 is a computing device for executing a deployed agentic system 237. Target computing device 230 includes, without limitation, one or more processors 232, memory 235, and communications interface 231.

The one or more processors 232 include any suitable processors implemented as part of a central processing unit (CPU), a GPU, an ASIC, a FPGA, an AI accelerator, or any other type of processor, or a combination of different processors, such as a CPU configured to operate in conjunction with a GPU. In general, the one or more processors 232 can be any technically feasibly hardware unit capable of processing data and/or executing software applications.

Memory 235 includes a RAM module, a flash memory unit, and/or any other type of memory unit or combination thereof. The one or more processors 232 and/or communications interface 231 are configured to read data from and write data to memory 235. Memory 235 can further include additional types of storage including, but not limited to, one or more fixed or removable disk drives, HDDs, SSD, NVMes, vDisks, flash memory devices, and/or other magnetic, optical, and/or solid-state storage devices. Memory 235 includes various software instructions that can be executed by the one or more processors 232 and application data associated with those software programs. As shown, memory 235 contains agentic framework 236, which contains deployed agentic system 237.

Communications interface 231 includes any technically feasible interface for coupling target computing device 230 and the one or more processors 232 with network 240. Communications interface 231 can include one or more hardware or software components. For example, communications interface 231 can provide an interface that is compliant with one or more wired or wireless Ethernet standards, and/or the like.

Agentic framework 236 provides the execution context of the deployed agentic system 237. Agentic framework 236 corresponds to the target agentic framework determined by agentic converter module 226. Target agentic frameworks can include HuggingFace SmolAgents, Langgraph, Nvidia AgentIQ, CrewAI, Autogen by Microsoft, and/or other available agentic frameworks.

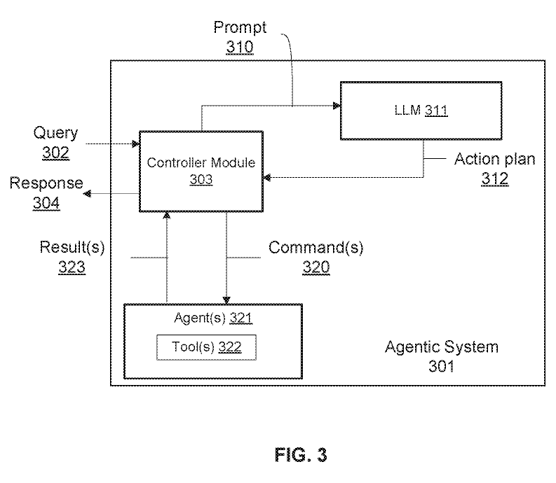

Deployed agentic system 237 is the converted agentic system that performs the tasks for which agentic system design 217 was designed. Deployed agentic system 237 contains the converted LLM, a converted controller module, one or more converted agents, any necessary tools, and/or similar converted elements of an agentic system. The controller module manages the context and execution state of the LLM, the agent(s), and any necessary tools. The controller module provides prompts generated from the template prompts of the common agentic framework to the LLM. In response, the LLM generates a series of one or more steps in the action plan to be executed by deployed agentic system 237 and returns the action plan back to the controller module. The controller module then submits the steps of the action plan to one or more agents as commands. In some embodiments, the controller module sends command(s) to one or more supervisory agents, which then delegates the command(s) to secondary agents. In some embodiments, agent(s) utilize one more tools deployed as part of deployed agentic system 237 to complete these commands. The controller module provides runtime statistics to agentic monitor module 227 over the course of execution so that agentic monitor module 227 can make any necessary modifications. Finally, the controller module of deployed agentic system 237 returns one or more results to the user. The details of an agentic system, such as deployed agentic system 237, are described in further detail in FIG. 3.

FIG. 3 is a block diagram of an agentic system 301, according to various embodiments. As shown, agentic system 301 includes, without limitation, a controller module 303, an LLM 311, and one or more agents 321. Controller module 303 receives a query 302 and returns a response 304. LLM 311 receives a prompt 310 from controller module 303 and returns an action plan 312 to controller module 303. Agent(s) 321 receives one or more commands 320 from the controller module 303 and return one or more result(s) 323 to controller module 303. In some embodiments, agent(s) 321 contain and/or have access to one or more tools 322 that are used in the process of completing a command 320.

In simple cases, elements of the agentic system 301 work together to linearly complete one or more tasks or in more complex designs create a feedback loop to accomplish one or more tasks. As shown in FIG. 3, query 302 is provided to agentic system 301, which is received by controller module 303. Query 302 can originate from a user or another system. For example, query 302 can provide a description of an initial task for agentic system 301 to perform. In some embodiments, query 302 is a question in natural language to be used as a prompt 310 by LLM 311. In some embodiments, query 302 is a desired set of results of the agentic system.

Controller module 303 analyzes query 302 to determine a goal for agentic system 301. Controller module 303 then converts query 302 into prompt 310 for LLM 311 to request that LLM 311 generate action plan 312 for satisfying query 302. Controller module 303 receives action plan 312 from LLM 311 and converts action plan 312 to command(s) 320 for agent(s) 321 and then asking agent(s) 321 to perform aspects of action plan 312. Controller module 303 then receives result(s) 323 from agent(s) 321 and generates response 304 from result(s) 323. In some embodiments, controller module 303 also provides at least one of result(s) 323 to an agent 321 as part of a command 320 in furtherance of action plan 312. In some embodiments, controller module 303 provides a result 323 from agent(s) 321 as at least a portion of a further prompt 310 for LLM 311 to provide an amended action plan 312. Upon completion of action plan 312, the controller module 303 returns a response 304 to query 302. In some embodiments, controller module 303 further provides information on query 302, the processing to satisfy query 302, and/or the like to agentic monitor module 227.

Controller module 303 manages the execution and state of all agent(s) 321 according to action plan 312. In some embodiments, controller module 303 uses multiple agents 321 to complete aspects of action plan 312 concurrently. Controller module 303 maintains any necessary input or context for agent(s) 321, such as API parameters, login information, and/or the like. Controller module 303 also provides data to agentic monitor module 227 that is used to determine whether agentic system 301 needs modification to execute successfully, as described in FIG. 4. Controller module 303 can also maintain which agent(s) 321 of the agentic system 301 are best suited for categories of tasks. For example, the controller module 303 can prefer to send multiple commands 320 to an agent 321 that uses a particular tool 322 but can refrain from sending a tool-specific agent 321 tasks that require calls to an external API. In some embodiments, controller module 303 also coordinates tasks on remote agents. For example, an agent 321 that is best suited for a given task can be called via an API on the internet and controller module 303 integrates the state of these calls on agentic system 301.

LLM 311 is a generative AI model, such as transformer-based language model. LLM 311 converts prompts 310 to action plan 312 for agentic system 301. LLM 311 receives prompt 310 from controller module 303. LLM 311 then processes prompt 310 and returns action plan 312 back to controller module 303. In some embodiments, action plan 312 includes instructions for controller module 303 to execute steps in parallel using agent(s) 321. In some cases, prompt 310 includes result 323 of a command 320 executed by an agent 321.

Action plan 312 can contain one or more executable steps by agent(s) 321 of agentic system 301 to complete query 302. For example, LLM 311 can generate steps of action plan 312 that are suited to condition based tasks of agent(s) 321.

Command(s) 320 are executed by agent(s) 321 as designated by action plan 312. Agent(s) 321 can each utilize one or more tools 322 designed to perform a specific task. Agent(s) 321 interact with tool(s) 322 using modifications designed to allow agent(s) 321 to communicate with any number of such tools 322. For example, agent 321 can communicate with a tool 322 by adding an MCP layer on top of tool 322. In some embodiments, agent 321 interacts with multiple tools 322 using an MCP to execute multiple tasks concurrently, returning results 323 of such tasks to controller module 303. Examples of agent(s) 321 can include simple agents that accomplish a single task, such as executing an application programming interface (API) and returning the result; or utility based agents that use information of the task and possible outcomes to achieve a larger goal such as monitoring the results of multiple API calls and choosing an ideal outcome from all returned results. Agent(s) 321 then return result 323 of command(s) 320 to controller module 303. In some embodiments, controller module 303 then calls the agent(s) 321 again to complete subsequent steps of action plan 312. Additionally, controller module 303 maintains the state of concurrent commands 320 executed by agent(s) 321. Command(s) 320 are executed by agent(s) 321 until action plan 312 is complete or action plan 312 is amended by sending a new prompt 310 to LLM 311 based on data provided by agent(s) 321.

FIG. 4 is a process flow 400 illustrating monitoring and redeployment of an agentic system, according to various embodiments. As shown, process flow 400 includes, without limitation, agentic monitor module 227, agentic converter module 226, deployed agentic system 237, and agentic deployment module 228. Agentic monitor module 227 contains, without limitation, an analyzer module 402. Analyzer module 402 receives activity data 403 from deployed agentic system 237. Agentic monitor module 227 determines whether deployed agentic system 237 requires one or more supplemental agentic systems to accomplish an agentic system design (e.g., agentic system design 217). Deployed agentic system 237 supplies activity data 403 to agentic monitor module 227.

Activity data 403 contains runtime metrics reported to agentic monitor module 227 by the controller module (e.g., controller module 303) of deployed agentic system 237. Examples of activity data 403 can include success or failure metrics of command(s) 320 executed by agent(s) 321, execution logs of command(s) 320 detailing completion time, CPU or memory utilization of agentic system 301, numbers of queries being processed, number of users or clients being supported, and/or the like. In some embodiments, activity data 403 is provided by one or more reporting agents added to deployed agentic system 237. As shown, activity data 403 is provided as input to analyzer module 402 contained in agentic monitor module 227. Analyzer module 402 then analyzes and/or aggregates activity data 403, including the runtime statistics. Based on the analysis, analyzer module 402 determines configurations for any additional computing resources to further support deployed agentic system 237. Analyzer module 402 then provides any modifications as input to agentic converter module 226. Analyzer module 402 provides the output of agentic converter module 226 to agentic deployment module 228 to modify deployed agentic system 237.

Analyzer module 402 uses an LLM, heuristic rules, and/or the like to determine the modifications to the deployed agentic system 237 based on activity data 403. For example, analyzer module 402 can analyze overall failure rate for commands 320, linear predictions of completion time of a typical action plan 312, overall system CPU and memory resource usage by the deployed agentic system 237, and/or similar analyses to determine the state of deployed agentic system 237. In some embodiments, the heuristic rules are determined from previously observed behaviors of the elements of deployed agentic system 237, publicly available documentation of deployed agentic system 237 or similar agentic systems, configuration details of the target computing device 230, and/or the like. Based on the state of deployed agentic system 237, analyzer module 402 determines whether deployed agentic system 237 should be converted to a different agentic framework, should be supplemented by additional agentic systems, should have additional agent(s) deployed, and/or the like.

Modifications to deployed agentic system 237 include converting one more additional agents, creating one or more additional agentic systems to supplement deployed agentic system 237, converting deployed agentic system 237 to a different target agentic framework, allocating additional computing resources (e.g., CPU or GPU cores or memory) to the target computing device 230, and/or the like. Creating additional instances of deployed agentic system 237 and/or generating one or more additional agents 321 are examples of horizontally scaling of deployed agentic system 237 to reduce runtime bottlenecks. For example, deployed agentic system 237 might require low latency in result(s) 323 from agent(s) 321; thus analyzer module 402 can determine that one or more additional instances of agent(s) 321 can be utilized to reduce latency across deployed agentic system 237. As another method of horizontal scaling, analyzer module 402 can determine whether concurrent instances of deployed agentic system 237 can be utilized to satisfy performance requirements of agentic system design 217. In some embodiments, multiple deployed agentic systems 237 are deployed to concurrently complete discrete stages of agentic system design 217 that do not require context from other stages of agentic system design 217. In some embodiments, analyzer module 402 uses heuristic rules to analyze command(s) 320 queued for execution by controller module 303 using agent(s) 321 and determines that additional agent(s) 321 should be provisioned to the target computing device 230 and deployed agentic system 237 where computing resources allow. Analyzer module 402 can also determine whether deployed agentic system 237 should be converted to a different target agentic framework. In some embodiments, analyzer module 402 uses heuristic rules to determine that result(s) 323 are not meeting a threshold number of successful calls and action plan 312 is changing too frequently; thus, requiring a different agentic framework to support agentic system design 217. For example, analyzer module 402 can determine that command(s) 320 are affected by a software defect in agent(s) 321 that prevents ideal result(s) 323 and can determine that deployed agentic system 237 should be converted to a different target agentic framework. Additionally, analyzer module 402 can determine that vertical scaling, such as providing additional computing resources, is required by deployed agentic system 237 to meet performance requirements or handle increases in workload. For example, when deployed agentic system 237 is utilizing a high proportion of computing resources such as CPU, memory, and/or the like of target computing device 230, analyzer module 402 can create an additional deployed agentic system 237 on a separate target computing device 230 to accommodate the load. In some embodiments, analyzer module 402 increases the available CPU cores and memory of target computing device 230 to supply deployed agentic system 237 with additional computing resources during execution.

In scenarios where analyzer module 402 determines whether horizontal or vertical scaling is required, analyzer module 402 determines how many additional agents, computing resources, and/or the like should be provided to deployed agentic system 237. Analyzer module 402 then modifies the configuration of target computing device 230, modifies the configuration of deployed agentic system 237, modifies similar configurations to increase available resources to the deployed agentic system 237, identifies additional computing devices, and/or the like. For example, analyzer module 402 can determine that additional virtual CPU or GPU cores on a virtualized computing system should be allocated for use by deployed agentic system 237. Analyzer module 402 can then communicate with the hypervisor of the virtualized computing system to determine the number additional CPU or GPU cores available. Analyzer module 402 can then modify the configuration of the virtual computing environment and provision the virtual computing environment using these modified configurations.

In scenarios where analyzer module 402 determines that deployed agentic system 237 should be converted to a different target agentic framework, analyzer module 402 supplies analyses of deployed agentic system 237 and/or selects the new target agentic framework to agentic converter module 226. Agentic converter module 226 then modifies deployed agentic system 237 based on these analyses and/or the new agentic target agentic framework. In some embodiments, agentic converter module 226 replaces one or more components of deployed agentic system 237 with one or more elements configured for the new target agentic framework without replacing all of the elements. Once agentic converter module 226 generates relevant modifications to deployed agentic system 237, the new configuration(s) are returned to analyzer module 402 as a new deployment package.

Analyzer module 402 then provides the new deployment package to agentic deployment module 228. Agentic deployment module 228 then deploys modified and/or additional deployed agentic system(s) 237 to one or more target computing devices.

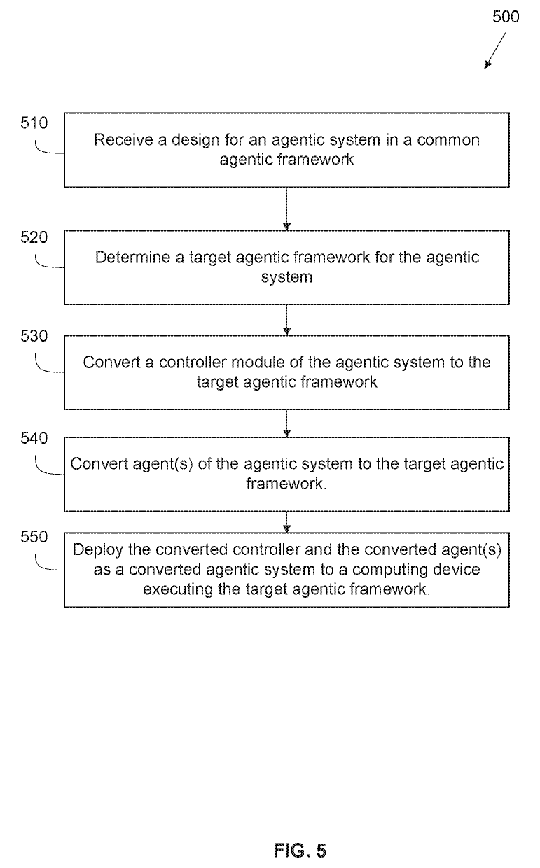

FIG. 5 is a flow diagram of method steps for converting an agentic system to a target agentic framework, according to various embodiments. Although the method steps are described in conjunction with FIGS. 1A-3, persons of ordinary skill in the art will understand that any system configured to perform the method steps, in any order, is within scope of the invention.

As shown, a method 500 begins at a step 510, where agentic converter module 226 receives an agentic system design 217 in a common agentic framework. Agentic system design 217 can be received from client computing device 210 and received via an API, loaded from a file or package selected by a user, received from agentic monitor module 227, and/or the like.

At a step 520, agentic converter module 226 determines a target agentic framework for the agentic system. Agentic converter module 226 analyzes one or more properties of agentic system device 217 to determine a suitable target agentic framework. Agentic converter module 226 uses one or more LLMs, heuristic rules, and/or the like to identify properties of the agentic system. Examples of such properties include a profile of the tasks of the agentic system or initial details of an agentic controller module of agentic system design 217. Agentic converter module 226 creates an initial target agentic system from these properties for which further components can be generated or modified by agentic converter module 226 in subsequent method steps. One or more elements of the target agentic framework can alternatively be specified by a user or agentic monitor module 227.

At a step 530, agentic converter module 226 converts a controller module of the agentic system to the target agentic framework. Agentic converter module 226 uses one or more LLMS, heuristic rules, and/or the like to convert an appropriate controller module for the target agentic system. For example, the controller module could be controller module 303 that manages the context of one or more agents 321, LLM 311, and any tools 322 of the converted agentic system 301. In some embodiments, agentic converter module 226 additionally updates controller module 303 to support communication with agentic monitor module 227 and monitoring of the agentic system by agentic monitor module 227. Agentic converter module 226 can additionally configure the controller module 303 to manage one or more tools 322 utilized by agent(s) 321 of agentic system 301.

At a step 540, agentic convert module 226 converts one or more agents of the agentic system to the target agentic framework. Agentic converter module 226 uses one or more LLMs, heuristic rules, and/or the like to determine the agent(s) to convert the one or more agents to the target agentic framework. Agentic converter module 226 can then convert and provide any parameters for any agent(s), such as API credentials, API parameters, and/or the like. In some embodiments, agentic converter module 226 supplies optimizations to one or more agents. Examples of such optimizations include optimizing the model context protocol (MCP) interface for one or more HuggingFace SmolAgents for use with controller module 303. Agentic converter module 226 can also create and convert agents solely for interacting with other agents of the agentic system within the target agentic framework. In some embodiments, agentic converter module 226 creates an agent that acts as a supervisory agent to the other agents in the agentic system.

At a step 550, the converted controller module and converted agent(s) are deployed as a converted agentic system to a computing device executing the target agentic framework. Agentic converter module 226 creates a deployment package suitable for deployment in the target agentic framework containing the converted controller module 303, one or more converted agents 321, and any tools 322. Agentic controller module 303 also provides specifications for target computing device 230, such as computing resources, deployment location, and/or the like required for the target agentic system based on properties of the target agentic system. Agentic converter module 226 then provides the deployment package to agentic deployment module 228 to facilitate the deployment of deployed agentic system 237.

FIG. 6 is a flow diagram of method steps for monitoring and redeploying an agentic system, according to some embodiments. Although the method steps are described in conjunction with FIGS. 1A-4, persons of ordinary skill in the art will understand that any system configured to perform the method steps, in any order is within scope of the invention.

As shown, a method 600 begins at a step 610, where agentic monitor module 227 monitors the runtime of deployed agentic system 237. Agentic monitor module 227 receives activity data from deployed agentic system 237. For example, activity data 403 can include success or failure metrics of commands (e.g. command(s) 320) performed by agents of deployed agentic system 237, execution logs of command(s) 320 detailing completion time, CPU or memory utilization of deployed agentic system 237, and/or the like. Agentic monitor module 227 provides activity data 403 as input to analyzer module 402.

At a step 620, analyzer module 402 receives and analyzes activity data 403 from the deployed agentic system 237. Analyzer module 402 aggregates and/or analyzes runtime statistics, success metrics, and/or the like of activity data 403. For example, analyzer module 402 can analyze overall failure rate for commands, linear predictions of completion time of a typical action plan 312, overall system CPU and memory resource usage by the deployed agentic system 237, and/or similar analyses to determine the state of deployed agentic system 237.

At an optional step 630, analyzer module 402 determines whether to convert additional agent(s) for the deployed agentic system. Analyzer module 402 uses an LLM, heuristic rules, and/or the like to determine whether one or more additional agents should be supplied to the agentic system. These additional agents can be used to reduce runtime bottlenecks of the deployed agentic system 237. Analyzer module 402 determines how many additional agent(s) should be provided to deployed agentic system 237 to alleviate these bottlenecks. For example, deployed agentic system 237 might require low latency in result(s) 323 from agent(s) 321; thus analyzer module 402 can determine one or more additional instances of agent(s) 321 can be utilized to reduce latency across deployed agentic system 237. In some embodiments, analyzer module 402 uses heuristic rules to analyze command(s) 320 queued for execution by controller module 303 using agent(s) 321 and determines that additional agent(s) 321 should be provisioned to the target computing device 230 and deployed agentic system 237 where computing resources allow.

At an optional step 640, analyzer module 402 determines whether to convert additional agentic system(s) to supplement the deployed agentic system. Analyzer module 402 uses an LLM, heuristic rules, and/or the like to determine whether additional instances of the deployed agentic system should be generated to increase execution speed of agentic system design 217 and supplies input to agentic converter module 226 to generate these additional agentic system(s). Analyzer module 402 determines how many additional agentic system(s) should be converted to efficiently complete agentic system design 217. In some embodiments, multiple deployed agentic systems 237 are deployed to concurrently complete discrete stages of agentic system design 217 that do not require context from other stages of agentic system design 217. Analyzer module 402 can also determine that additional agentic system(s) should be deployed to separate target computing device(s) 230 to accommodate the increased load.

At an optional step 650, analyzer module 402 determines whether the deployed agentic system 237 should be converted to a different target agentic framework. Analyzer module 402 uses heuristic rules to determine whether the target agentic framework of the deployed agentic system 237 needs conversion to a different target agentic framework. For example, analyzer module 402 can determine that software defects in one or more agents 321 are affecting the outcome of the agentic system and these agents should be converted to another target agentic framework. Agentic converter module 226 utilizes these analyses in subsequent method steps to determine an appropriate target agentic framework.

At a step 660, agentic converter module 226 modifies the deployment package of the deployed agentic system 237 to reflect changes to the agentic system determined by analyzer module 402. Modifications to the deployment package are dependent on which of the one or more optional modifications are provided by analyzer module 402. Agentic converter module 226 then converts additional agent(s) 321 to the target agentic system; generates additional agentic system(s); and/or determines the appropriate new target agentic framework to convert the deployed agentic system 237. Agentic converter module 226 then modifies the deployment package to accommodate these modifications to the deployed agentic system 237. In some embodiments, agentic converter module 226 can selectively modify one or more components of deployed agentic system 237 to the new target agentic framework without replacing all of the elements. In some embodiments, the controller module 303 of the deployed agentic system 237 is also modified to communicate with the additional agent(s) 321.

At an optional step 670, analyzer module 402 provides additional computing resources to deployed agentic system 237. Analyzer module 402 analyzes the computing resources utilized by the deployed agentic system 237, such as CPU and/or memory, relative to resources available to target computing device 230. Analyzer module 402 can then determine appropriate additional resources to allocate to target computing device 230 to meet performance requirements or handle increases in workload. Additionally, analyzer module 402 can determine whether additional agentic system(s), such as those described in a method step 640, should be deployed on separate target computing device(s) 230 as a strategy to provide additional computing resources to the agentic system(s). Agentic analyzer module 402 can also allocate additional computing resources to the deployed agentic system 237 to accommodate any additional agent(s) that may be deployed.

At a step 680, agentic deployment module 228 deploys the modified deployment package of the target agentic system to a computing device for execution. Agentic converter module 226 provides the modified deployment package to agentic deployment module 228 for deployment. Agentic deployment module 228 then deploys modified and/or additional deployed agentic system(s) 237 to one or more target computing devices 230.

In sum, the disclosed techniques provide a common multi-agent framework for different agentic backends. The disclosed techniques include receiving a design for an agentic system that is described using a common agentic framework. A target agentic framework is determined that is appropriate for the agentic system. The agentic system is then converted from the common agentic framework to the target agentic framework. This creates a converted agentic system that can be deployed on a computing environment that supports the target agentic framework. The converted agentic system is then deployed to a target computing environment that is supporting the target agentic framework. In some embodiments, the deployed agentic systems are monitored for performance characteristics while performing their agentic tasks. The disclosed techniques then modify the agentic system to optimize performance of the agentic system. Modifications include generating additional agentic systems in the same or differing agentic framework, generating additional elements of the agentic system, modifying elements of the agentic system, or providing additional computing resources to the agentic system.

At least one technical advantage of the disclosed techniques relative to the prior art is that with the disclosed techniques, the target agentic framework for an agentic system design is determined automatically. As a result, the agentic system can utilize an appropriate target agentic framework that may not be known by the developer as the target agentic framework of the agentic system. An additional technical advantage of the disclosed techniques is that the agentic system is monitored after deployment allowing agentic system to be automatically scaled, configured with additional resources, and/or converted to a different target agentic framework that is more suitable for the design and/or workload of the agentic system. These technical advantages provide one or more technological improvements over prior art approaches.

Aspects of the subject matter described herein are set out in the following numbered clauses.
1. In some embodiments, one or more non-transitory computer-readable media store program instructions that, when executed by one or more processors associated with a first computing device, cause the one or more processors to perform a method comprising receiving a design for an agentic system in a common agentic framework, determining a target agentic framework for the agentic system, converting the agentic system from the common agentic framework to the target agentic framework to generate a converted agentic system, and deploying the converted agentic system to a target computing environment.
2. The one or more non-transitory computer-readable media of clause 1, wherein the agentic system includes a large language model.
3. The one or more non-transitory computer-readable media of clauses 1 or 2, wherein the common agentic framework supports features for a plurality of frameworks including the target agentic framework.
4. The one or more non-transitory computer-readable media of any of clauses 1-3, wherein the agentic system comprises a plurality of agents.
5. The one or more non-transitory computer-readable media of any of clauses 1-4, wherein converting the agentic system to generate the converted agentic system comprises converting a first agent of the plurality of agents to the target agentic framework, and converting a second agent of the plurality of agents to a second target agentic framework different from the target agentic framework.
6. The one or more non-transitory computer-readable media of any of clauses 1-5, wherein converting the agentic system to generate the converted agentic system comprises adding one or more reporting or supervisory agents to the converted agentic system.
7. The one or more non-transitory computer-readable media of any of clauses 1-6, wherein the method further comprises monitoring the converted agentic system, and making one or more changes to the converted agentic system based on the monitoring.
8. The one or more non-transitory computer-readable media of any of clauses 1-7, wherein the agentic system is specified in the common agentic framework using one or more Kubernetes common resource definitions.
9. The one or more non-transitory computer-readable media of any of clauses 1-8, wherein the method further comprises converting the agentic system from the common agentic framework to a second target agentic framework to generate a second converted agentic system, the second target agentic framework being different from the target agentic framework, and deploying the second converted agentic system to a second target computing environment.
10. The one or more non-transitory computer-readable media of any of clauses 1-9, wherein determining the target agentic framework comprises receiving a selection of the target agentic framework from a user or a monitor module.
11. The one or more non-transitory computer-readable media of any of clauses 1-10, wherein determining the target agentic framework comprises selecting the target agentic framework based on one or more properties of the agentic system.
12. The one or more non-transitory computer-readable media of any of clauses 1-11, wherein the method further comprises receiving, by the converted agentic system, a query, creating, by the converted agentic system, an action plan, and performing, by the converted agentic system, the action plan.
13. In some embodiments, a computer-implemented method for deploying an agentic system, the computer-implemented method comprises receiving a design for an agentic system in a common agentic framework, determining a target agentic framework for the agentic system, converting the agentic system from the common agentic framework to the target agentic framework to generate a converted agentic system, and deploying the converted agentic system to a target computing environment.
14. The computer-implemented method of clause 13, wherein the agentic system includes a large language model.
15. The computer-implemented method of clauses 13 or 14, wherein the common agentic framework supports features for a plurality of frameworks including the target agentic framework.
16. The computer-implemented method of any of clauses 13-15, wherein the agentic system comprises a plurality of agents.
17. The computer-implemented method of any of clauses 13-16, wherein converting the agentic system to generate the converted agentic system comprises converting a first agent of the plurality of agents to the target agentic framework, and converting a second agent of the plurality of agents to a second target agentic framework different from the target agentic framework.
18. The computer-implemented method of any of clauses 13-17, wherein converting the agentic system to generate the converted agentic system comprises adding one or more reporting or supervisory agents to the converted agentic system.
19. The one or more non-transitory computer-readable media of any of clauses 13-18, further comprising monitoring the converted agentic system, and making one or more changes to the converted agentic system based on the monitoring.
20. The computer-implemented method of any of clauses 13-19, wherein the agentic system is specified in the common agentic framework using one or more Kubernetes common resource definitions.
21. The computer-implemented method of any of clauses 13-20, further comprising converting the agentic system from the common agentic framework to a second target agentic framework to generate a second converted agentic system, the second target agentic framework being different from the target agentic framework, and deploying the second converted agentic system to a second target computing environment.
22. The computer-implemented method of any of clauses 13-21, wherein determining the target agentic framework comprises receiving a selection of the target agentic framework from a user or a monitor module.
23. The computer-implemented method of any of clauses 13-22, wherein determining the target agentic framework comprises selecting the target agentic framework based on one or more properties of the agentic system.
24. The computer-implemented method of any of clauses 13-23, further comprising receiving, by the converted agentic system, a query, creating, by the converted agentic system, an action plan, and performing, by the converted agentic system, the action plan.
25. In some embodiments, a computing system comprises memory storing instructions, and one or more processors coupled to the memory and, when executing the instructions, are configured to perform a method comprising receiving a design for an agentic system in a common agentic framework, determining a target agentic framework for the agentic system, converting the agentic system from the common agentic framework to the target agentic framework to generate a converted agentic system, and deploying the converted agentic system to a target computing environment.
26. The computing system of clause 25, wherein the agentic system includes a large language model.
27. The computing system of clauses 25 or 26, wherein the common agentic framework supports features for a plurality of frameworks including the target agentic framework.
28. The computing system of any of clauses 25-27, wherein the agentic system comprises a plurality of agents.
29. The computing system of any of clauses 25-28, wherein converting the agentic system to generate the converted agentic system comprises converting a first agent of the plurality of agents to the target agentic framework, and converting a second agent of the plurality of agents to a second target agentic framework different from the target agentic framework.
30. The computing system of any of clauses 25-29, wherein converting the agentic system to generate the converted agentic system comprises adding one or more reporting or supervisory agents to the converted agentic system.
31. The computing system of any of clauses 25-30, wherein the method further comprises monitoring the converted agentic system, and making one or more changes to the converted agentic system based on the monitoring.
32. The computing system of any of clauses 25-31, wherein the agentic system is specified in the common agentic framework using one or more Kubernetes common resource definitions.
33. The computing system of any of clauses 25-32, wherein the method further comprises converting the agentic system from the common agentic framework to a second target agentic framework to generate a second converted agentic system, the second target agentic framework being different from the target agentic framework, and deploying the second converted agentic system to a second target computing environment.
34. The computing system of any of clauses 25-33, wherein determining the target agentic framework comprises receiving a selection of the target agentic framework from a user or a monitor module.
35. The computing system of any of clauses 25-34, wherein determining the target agentic framework comprises selecting the target agentic framework based on one or more properties of the agentic system.
36. The computing system of any of clauses 25-35, wherein the method further comprises receiving, by the converted agentic system, a query, creating, by the converted agentic system, an action plan, and performing, by the converted agentic system, the action plan.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. One or more non-transitory computer-readable media storing program instructions that, when executed by one or more processors associated with a first computing device, cause the one or more processors to perform a method comprising:
receiving a design for an agentic system in a common agentic framework;
determining a target agentic framework for the agentic system;
converting the agentic system from the common agentic framework to the target agentic framework to generate a converted agentic system; and
deploying the converted agentic system to a target computing environment.

2. The one or more non-transitory computer-readable media of claim 1, wherein the agentic system includes a large language model.

3. The one or more non-transitory computer-readable media of claim 1, wherein the common agentic framework supports features for a plurality of frameworks including the target agentic framework.

4. The one or more non-transitory computer-readable media of claim 1, wherein the agentic system comprises a plurality of agents.

5. The one or more non-transitory computer-readable media of claim 4, wherein converting the agentic system to generate the converted agentic system comprises:
converting a first agent of the plurality of agents to the target agentic framework; and
converting a second agent of the plurality of agents to a second target agentic framework different from the target agentic framework.

6. The one or more non-transitory computer-readable media of claim 4, wherein converting the agentic system to generate the converted agentic system comprises adding one or more reporting or supervisory agents to the converted agentic system.

7. The one or more non-transitory computer-readable media of claim 1, wherein the method further comprises:
monitoring the converted agentic system; and
making one or more changes to the converted agentic system based on the monitoring.

8. The one or more non-transitory computer-readable media of claim 1, wherein the agentic system is specified in the common agentic framework using one or more Kubernetes common resource definitions.

9. The one or more non-transitory computer-readable media of claim 1, wherein the method further comprises:
converting the agentic system from the common agentic framework to a second target agentic framework to generate a second converted agentic system, the second target agentic framework being different from the target agentic framework; and
deploying the second converted agentic system to a second target computing environment.

10. The one or more non-transitory computer-readable media of claim 1, wherein determining the target agentic framework comprises receiving a selection of the target agentic framework from a user or a monitor module.

11. The one or more non-transitory computer-readable media of claim 1, wherein determining the target agentic framework comprises selecting the target agentic framework based on one or more properties of the agentic system.

12. The one or more non-transitory computer-readable media of claim 1, wherein the method further comprises:
receiving, by the converted agentic system, a query;
creating, by the converted agentic system, an action plan; and
performing, by the converted agentic system, the action plan.

13. A computer-implemented method for deploying an agentic system, the computer-implemented method comprising:
receiving a design for an agentic system in a common agentic framework;
determining a target agentic framework for the agentic system;
converting the agentic system from the common agentic framework to the target agentic framework to generate a converted agentic system; and
deploying the converted agentic system to a target computing environment.

14. The computer-implemented method of claim 13, wherein the agentic system includes a large language model.

15. The computer-implemented method of claim 13, wherein the common agentic framework supports features for a plurality of frameworks including the target agentic framework.

16. The computer-implemented method of claim 13, wherein the agentic system comprises a plurality of agents.

17. The computer-implemented method of claim 16, wherein converting the agentic system to generate the converted agentic system comprises:
converting a first agent of the plurality of agents to the target agentic framework; and
converting a second agent of the plurality of agents to a second target agentic framework different from the target agentic framework.

18. The computer-implemented method of claim 16, wherein converting the agentic system to generate the converted agentic system comprises adding one or more reporting or supervisory agents to the converted agentic system.

19. The computer-implemented method of claim 13, further comprising:
monitoring the converted agentic system; and
making one or more changes to the converted agentic system based on the monitoring.

20. The computer-implemented method of claim 13, wherein the agentic system is specified in the common agentic framework using one or more Kubernetes common resource definitions.

21. The computer-implemented method of claim 13, further comprising:
converting the agentic system from the common agentic framework to a second target agentic framework to generate a second converted agentic system, the second target agentic framework being different from the target agentic framework; and
deploying the second converted agentic system to a second target computing environment.

22. The computer-implemented method of claim 13, wherein determining the target agentic framework comprises receiving a selection of the target agentic framework from a user or a monitor module.

23. The computer-implemented method of claim 13, wherein determining the target agentic framework comprises selecting the target agentic framework based on one or more properties of the agentic system.

24. The computer-implemented method of claim 13, further comprising:
receiving, by the converted agentic system, a query;
creating, by the converted agentic system, an action plan; and
performing, by the converted agentic system, the action plan.

25. A computing system comprising:
memory storing instructions; and
one or more processors coupled to the memory and, when executing the instructions, are configured to perform a method comprising:
receiving a design for an agentic system in a common agentic framework;
determining a target agentic framework for the agentic system;
converting the agentic system from the common agentic framework to the target agentic framework to generate a converted agentic system; and
deploying the converted agentic system to a target computing environment.

26. The computing system of claim 25, wherein the agentic system includes a large language model.

27. The computing system of claim 25, wherein the common agentic framework supports features for a plurality of frameworks including the target agentic framework.

28. The computing system of claim 25, wherein the agentic system comprises a plurality of agents.

29. The computing system of claim 28, wherein converting the agentic system to generate the converted agentic system comprises:
converting a first agent of the plurality of agents to the target agentic framework; and
converting a second agent of the plurality of agents to a second target agentic framework different from the target agentic framework.

30. The computing system of claim 28, wherein converting the agentic system to generate the converted agentic system comprises adding one or more reporting or supervisory agents to the converted agentic system.

31. The computing system of claim 25, wherein the method further comprises:
monitoring the converted agentic system; and
making one or more changes to the converted agentic system based on the monitoring.

32. The computing system of claim 25, wherein the agentic system is specified in the common agentic framework using one or more Kubernetes common resource definitions.

33. The computing system of claim 25, wherein the method further comprises:
converting the agentic system from the common agentic framework to a second target agentic framework to generate a second converted agentic system, the second target agentic framework being different from the target agentic framework; and
deploying the second converted agentic system to a second target computing environment.

34. The computing system of claim 25, wherein determining the target agentic framework comprises receiving a selection of the target agentic framework from a user or a monitor module.

35. The computing system of claim 25, wherein determining the target agentic framework comprises selecting the target agentic framework based on one or more properties of the agentic system.

36. The computing system of claim 25, wherein the method further comprises:
receiving, by the converted agentic system, a query;
creating, by the converted agentic system, an action plan; and
performing, by the converted agentic system, the action plan.
